(19) United States
(12) Patent Application Publication
(10) Pub. No.: US 2012/0175300 A1
(43) Pub. Date: Jul. 12, 2012

(54) TWO-LAYER MEMBRANE

(76) Inventor: John R. Herron, Corvallis, OR (US)

(21) Appl. No.: 13/348,620

(22) Filed: Jan. 11, 2012

Related U.S. Application Data
(60) Provisional application No. 61/431,563, filed on Jan. 11, 2011.

(51) Int. Cl. B01D 71/06; B05D 5/00; B05D 1/36; B01D 71/18

(52) U.S. Cl. 210/500.32; 210/500.27; 427/243

(57) ABSTRACT

A method of forming a two-layered membrane by immersion precipitation including: depositing a first hydrophilic polymer solution with a formulation optimized to produce a high performance porous layer; depositing on top of the first hydrophilic polymer solution a second, different hydrophilic polymer solution optimized to produce a high performance dense layer; and forming the two-layer polymer solution into one of a forward osmosis membrane and a pressure retarded osmosis membrane by bringing the second, different hydrophilic polymer solution into contact with water to form the dense layer. A two-layered membrane formed by immersion precipitation includes: a porous layer formed from a first hydrophilic polymer solution with a formulation optimized to produce a high performance porous layer; and a dense layer on top of and supported by the porous layer, the dense layer formed from a second, different hydrophilic polymer solution optimized to produce a high performance dense layer.

### CROSS-REFERENCE TO RELATED APPLICATION

This application claims priority to the pending provisional application entitled “TWO-LAYER MEMBRANE”, Ser. No. 61/431,563, filed Jan. 11, 2011, the entire disclosure of which is hereby incorporated herein by reference.

### BACKGROUND

1. Technical Field

This document relates to a two-layer membrane for forward osmosis (FO) and pressure retarded osmosis (PRO) membrane processes and applications, for example.

2. Background

The development of highly selective semi-permeable membranes has been primarily focused on reverse osmosis (RO). High performing RO membranes have a very thin, dense, polymeric layer that is supported by a mechanically strong porous membrane. The structure of the support membrane has little effect on the flux and selectivity of the membrane.

Recently, FO has received interest as well. FO membranes have similar species selectivity as RO membranes, but in FO the characteristics of the porous support layer (such as morphology and hydrophilicity) have a large effect on membrane performance.

Currently the only commercially available FO membrane is manufactured by Hydration Technology Innovations, LLC of Albany, OR (HTI). This is a cellulose triacetate (CTA) membrane with an embedded support screen cast using the immersion precipitation process. This membrane has a dense rejection layer (10-20 micron) far thicker than those common on composite RO membranes (0.2 micron). However, the HTI membrane far outperforms composite RO membranes in FO tests due to the openness and hydrophilicity of its porous support layer.

However, in many applications CTA membranes are not appropriate due to their limited pH tolerance. There are other cellulosic esters such as cellulose acetate butyrate (CAB) and cellulose acetate proprionate (CAP) that are more pH tolerant than CTA, but these have lower performance in FO when cast using the immersion precipitation process. Likewise, cellulose acetate (CA) membranes have higher flux in RO than CTA, which indicates the rejection layer of CA has superior transport properties. But CA performance in FO is worse than that of CTA due to the superior porous support layer of CTA.

### SUMMARY

Aspects of this document relate to two-layer membranes for forward osmosis (FO) and pressure retarded osmosis (PRO) membrane processes and applications, for example. These aspects may include, and implementations may include, one or more or all of the components and steps set forth in the appended CLAIMS, which are hereby incorporated by reference.

In one aspect, a method of forming a two-layered membrane by immersion precipitation is disclosed and includes: depositing a first hydrophilic polymer solution with a formulation optimized to produce a high performance porous layer; depositing on top of the first hydrophilic polymer solution a second, different hydrophilic polymer solution optimized to produce a high performance dense layer, thereby forming a two-layer polymer solution; and forming the two-layer polymer solution into one of a forward osmosis membrane and a pressure retarded osmosis membrane by bringing the second, different hydrophilic polymer solution into contact with water to form the dense layer.

Particular implementations may include one or more or all of the following.

Forming the two-layer polymer solution into one of a forward osmosis membrane and a pressure retarded osmosis membrane comprises forming the two-layer polymer solution into one of an asymmetric forward osmosis membrane and an asymmetric pressure retarded osmosis membrane by bringing the second, different hydrophilic polymer solution into contact with water to form the dense layer.

Forming the two-layer polymer solution into one of an asymmetric forward osmosis membrane and an asymmetric pressure retarded osmosis membrane comprises forming the dense layer comprising a thickness of about 5 to about 15 microns and the porous layer comprising a thickness of about 20 to about 150 microns.

Forming the two-layer polymer solution into one of an asymmetric forward osmosis membrane and an asymmetric pressure retarded osmosis membrane comprises forming the dense layer comprising a density of polymer of about 50% or greater polymer by volume and the porous layer comprising a density of polymer from about 15% to about 30% polymer by volume.

Depositing a first hydrophilic polymer solution comprises depositing a first cellulose triacetate solution; depositing on top of the first hydrophilic polymer solution a second, different hydrophilic polymer solution comprises depositing on top of the first cellulose triacetate solution one of a second cellulose acetate butyrate solution and a second cellulose acetate solution, thereby forming a two-layer polymer solution; and forming the two-layer polymer solution into one of an asymmetric forward osmosis membrane and an asymmetric pressure retarded osmosis membrane comprises forming the two-layer polymer solution into one of: an asymmetric forward osmosis membrane by bringing the second cellulose acetate butyrate solution into contact with water to form the dense layer; and an asymmetric pressure retarded osmosis membrane by bringing the second cellulose acetate solution into contact with water to form the dense layer.

Depositing a first hydrophilic polymer solution comprises depositing a first cellulose triacetate solution; depositing on top of the first hydrophilic polymer solution a second, different hydrophilic polymer solution comprises depositing on top of the first cellulose triacetate solution one of a second cellulose acetate butyrate solution and a second cellulose acetate solution, thereby forming a two-layer polymer solution; and forming the two-layer polymer solution into one of a forward osmosis membrane and a pressure retarded osmosis membrane comprises forming the two-layer polymer solution into one of: a forward osmosis membrane by bringing the second cellulose acetate butyrate solution into contact with water to form the dense layer; and a pressure retarded osmosis membrane by bringing the second cellulose acetate solution into contact with water to form the dense layer.

In another aspect, a two-layered membrane formed by immersion precipitation is disclosed and includes: a porous layer formed from a first hydrophilic polymer solution with a formulation optimized to produce a high performance porous layer; and a dense layer on top of and supported by the porous layer, the dense layer formed from a second, different hydrophilic polymer solution optimized to produce a high performance dense layer.

Particular implementations may include one or more or all of the following.

The membrane is an asymmetric membrane. The dense layer comprises a thickness of about 5 to about 15 microns and the porous layer comprises a thickness of about 20 to about 150 microns. The dense layer comprises a density of polymer of about 50% or greater polymer by volume and the porous layer comprises a density of polymer from about 15% to about 30% polymer by volume.

The asymmetric membrane comprises an asymmetric forward osmosis membrane with the porous layer formed from a first cellulose triacetate solution and the dense layer formed from a second cellulose acetate butyrate solution.

The asymmetric membrane comprises an asymmetric pressure retarded osmosis membrane with the porous layer formed from a first cellulose triacetate solution and the dense layer formed from a second cellulose acetate solution.

The membrane comprises a forward osmosis membrane with the porous layer formed from a first cellulose triacetate solution and the dense layer formed from a second cellulose acetate butyrate solution.

The membrane comprises a pressure retarded osmosis membrane with the porous layer formed from a first cellulose triacetate solution and the dense layer formed from a second cellulose acetate solution.

Implementations of two-layer membranes and processes may have one or more or all of the following advantages.

One two-layer membrane implementation may have an open, hydrophilic porous CTA support layer that allows for high mass transfer. It may also include a CAB rejection layer to provide both superior FO performance and pH tolerance.

Another two-layer membrane implementation may have an open, hydrophilic porous CTA support layer that allows for high mass transfer. It may also include a CA rejection layer to provide superior FO performance, raise membrane flux and improve the process economics of PRO.

The foregoing and other aspects, features, and advantages will be apparent to those of ordinary skill in the art from the DESCRIPTION and DRAWINGS, and from the CLAIMS.

### DESCRIPTION

This document features a two-layer membrane for forward osmosis (FO) and pressure retarded osmosis (PRO) membrane processes and applications, for example. One two-layer membrane implementation may have an open, hydrophilic porous CTA support layer (allows for the high mass transfer) and a CAB rejection layer to provide both superior FO performance and pH tolerance. Another two-layer membrane implementation may have an open, hydrophilic porous CTA support layer (allows for the high mass transfer) and a CA rejection layer to provide superior FO performance, raise membrane flux and improve the process economics of PRO. There are many features of a two-layer membrane and related process implementations disclosed herein, of which one, a plurality, or all features or steps might be used in any particular implementation.

In the following description, it is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

There are a variety of two-layer membrane implementations. Some couple the high mass transfer of the CTA support layer with a dense layer of CAB or CA to provide pH tolerance or higher membrane flux, respectively.

Notwithstanding, for the exemplary purposes of this disclosure, a process of forming two-layer membrane implementations may generally include casting a two-layer membrane by the immersion precipitation process. Such a process can produce, for example, a pliable membrane with the performance of CTA membranes but with the pH tolerance or higher membrane flux of CAB membranes or CA membranes, respectively.

The technique for forming a layered polymer solution that is then formed into a membrane is complicated. The keys are recognizing: 1) The structure of the porous layer is critically important to FO flux and gas membrane durability and it varies widely between CA, CAB and CTA; 2) All three cellulose esters are soluble in similar solvents and if brought into contact in layers they will not precipitate until the top layer is contacted with water; and 3) In the immersion precipitation process a dense layer will only form on the top layer. All layers below the surface layer will form a porous layer exclusively. This porous layer should have the structure typical to the polymer it is made of.

### Immersion Precipitation

In order to achieve optimal dense layer and porous layer performance simultaneously, two-layer membranes must be cast. The immersion precipitation process used here is similar to that disclosed in U.S. Pat. No. 3,133,1324 to Loeb and Sourirajan, the disclosure of which is hereby incorporated entirely herein by reference.

The process will entail depositing a layer of polymer solution with a formulation suitable to produce a high performance porous layer and then depositing a polymer solution optimized to produce a high performance dense layer on top of it. The two-layer polymer solution is then air treated and the second layer is brought into contact with water. The dense layer will form from the material optimized for dense layer characteristics and much of the porous layer will be formed from the material with optimum porous layer characteristics.

For the exemplary purposes of this disclosure, the process can entail forming a layer of CAB polymer solution or CA polymer solution and then depositing a thin layer of CTA polymer solution on top of the first layer. The two-layer polymer solution is then air treated and the CAB or CA layer is brought into contact with water. The dense layer will form from CAB or CA, respectively, and most of the porous layer will be formed from CTA.

A membrane polymeric material (e.g., hydrophilic polymer (e.g. cellulose ester)) is dissolved in water-soluble solvent (non-aqueous) system to form a solution. Appropriate water-soluble solvent systems for cellulosic membranes include, for example, (e.g. ketones (e.g., acetone, methyl ethyl ketone and 1,4-dioxane), ethers, alcohols). Also included/mixed in the solution are pore-forming agents (e.g. organic acids, organic acid salts, mineral salts, amides, and the like, such as malic acid, citric acid, lactic acid, lithium chloride, and the like for example) and strengthening agents (e.g., agents to improve pliability and reduce brittleness, such as methanol, glycerol, ethanol, and the like for example).

Thus, in one implementation, CTA is dissolved in water-soluble solvent (non-aqueous) system to form a first CTA solution.

Next, a thin layer of a second CAB or CA polymer solution may be deposited on top of the first CTA solution to form a viscous two-layer solution.

Next, a thin layer of this viscous two-layer solution can be placed or spread evenly on a surface and allowed to air dry for a short time (e.g. under an air knife).

Then the CAB or CA layer side of the viscous two-layer solution is brought into contact with water. The water contact causes the membrane components to coagulate and form the appropriate membrane characteristics (e.g., porosity, hydrophilic nature, asymmetric nature, and the like). Thus, the water contact causes the polymer in solution to become unstable and a layer of dense polymer precipitates on the surface very quickly. This layer acts as an impediment to water penetration further into the solution so the polymer beneath the dense layer precipitates much more slowly and forms a loose, porous matrix. The dense layer will form from CAB or CA and most of the porous layer will be formed from CTA. The dense layer is the portion of the membrane that allows the passage of water while blocking other species. The porous layer acts merely as a support for the dense layer. The support layer is needed because on its own a 10 micron thick dense layer, for example, would lack the mechanical strength and cohesion to be of any practical use.

After all the polymer is condensed from solution the membrane can be washed and heat treated.

Thus, in the foregoing examples, the immersion/precipitation process may form an asymmetric membrane with a solid dense or skin layer of CAB or CA as a surface component, having about 5-15 micrometers in thickness for example. Also formed is a porous or scaffold layer of mostly CTA, wherein the porous or scaffold layer is highly porous and allows diffusion of solids within the porous or scaffold layer. The porous or scaffold layer may have a thickness of 20 to 150 microns for example. The dense or skin layer and the porous or scaffold layer created by the immersion/precipitation process have their porosities controlled by both casting parameters (time, temperature, standard techniques, and the like) and by the choices of formulation components (solvent, ratio of solids of polymeric material to solvent solution, and the like). The porous or scaffold layer may have a density of polymer as low as possible, such as from about 15-30% polymer by volume. The top dense or skin layer may have a density of polymer of greater than 50% polymer.

In RO the flux of the membrane is overwhelmingly dependent on the thickness, composition and morphology of the dense or skin layer, so there has been little impetus to optimize the performance of the porous layer. However in FO and PRO, water is drawn through the membrane by a difference in dissolved species concentration across the dense layer. If the higher concentration is on the porous layer side of the dense layer, the water being pulled through the dense layer carries the dissolved species in the porous layer away from the dense layer. For the process to continue, the dissolved species must diffuse back through the porous layer to the dense layer. Likewise, if the higher concentration is on the open side of the dense layer, as water is extracted from the fluids in the porous layer, the concentration of dissolved species in the porous layer will increase. For the process to continue they must diffuse out of the back of the membrane into the feed solution.

Therefore, for the purposes of this disclosure, it is critical that the porous layer be as hydrophilic and open as possible so that it presents as small a resistance to diffusion as possible.

Many additional implementations are possible.

For the exemplary purposes of this disclosure, in one implementation the solution may be extruded onto a surface of a hydrophilic backing material. An air-knife may be used to evaporate some of the solvent to prepare the solution for formation of the dense or skin layer. The backing material with solution extruded on it is then introduced into a coagulation bath (e.g., water bath). The water bath causes the membrane components to coagulate and form the appropriate membrane characteristics (e.g., porosity, hydrophilic nature, asymmetric nature, and the like). In an FO process, water transport occurs through the holes of the mesh backing layer as the mesh backing fibers do not offer significant lateral resistance (that is, the mesh backing does not significantly impede water getting to surface of membrane). The membrane may have an overall thickness from about 10 micrometers to about 150 micrometers (excluding the porous backing material) for example. The porous backing material may have a thickness of from about 50 micrometers to about 500 micrometers in thickness for example.

For the exemplary purposes of this disclosure, in another implementation the solution may be cast onto a rotating drum and an open fabric is pulled into the solution so that the fabric is embedded into the solution. The solution is then passed under an air knife and into the coagulation bath. The membrane may have an overall thickness of 75 to 150 microns and the support fabric may have a thickness from 50 to 100 microns. The support fabric may also have over 50% open area. The support fabric may be a woven or nonwoven nylon, polyester or polypropylene, and the like for example, or it could be a cellulose ester membrane cast on a hydrophilic support such as cotton or paper.

Further implementations are within the CLAIMS.

### Specifications, Materials, Manufacture, Assembly

It will be understood that implementations are not limited to the specific components disclosed herein, as virtually any components consistent with the intended operation of a two-layer membrane may be utilized. Accordingly, for example, although particular components and so forth, are disclosed, such components may comprise any shape, size, style, type, model, version, class, grade, measurement, concentration, material, weight, quantity, and/or the like consistent with the intended operation of a two-layer membrane implementation. Implementations are not limited to uses of any specific components, provided that the components selected are consistent with the intended operation of a two-layer membrane implementation.

Accordingly, the components defining any two-layer membrane implementation may be formed of any of many different types of materials or combinations thereof that can readily be formed into shaped objects provided that the components selected are consistent with the intended operation of a polymer coated hydrolyzed membrane implementation. As a restatement of or in addition to what has already been described and disclosed above, the FO or PRO membrane may be made from a thin film composite RO membrane. Such membrane composites include, for example, a membrane cast by an immersion precipitation process (which could be cast on a porous support fabric such as woven or nonwoven nylon, polyester or polypropylene, or preferably, a cellulose ester membrane cast on a hydrophilic support such as cotton or paper). The membranes used may be hydrophilic, membranes with salt rejections in the 80% to 95% range when tested as a reverse osmosis membrane (60 psi, 500 PPM NaCl, 10% recovery, 25.degree. C.). The nominal molecular weight cut-off of the membrane may be 100 daltons. The membranes may be made from a hydrophilic membrane material, for example, cellulose acetate, cellulose proprianate, cellulose butyrate, cellulose diacetate, blends of cellulosic materials, polyurethane, polyamides. The membranes may be asymmetric (that is, for example, the membrane may have a thin rejection layer on the order of one (1) or less microns thick and a dense and porous sublayers up to 300 microns thick overall) and may be formed by an immersion precipitation process. The membranes are either unbacked, or have a very open backing that does not impede water reaching the rejection layer, or are hydrophilic and easily wick water to the membrane. Thus, for mechanical strength they may be cast upon a hydrophobic porous sheet backing, wherein the porous sheet is either woven or non-woven but having at least about 30% open area. The woven backing sheet may be a polyester screen having a total thickness of about 65 microns (polyester screen) and total asymmetric membrane is 165 microns in thickness. The asymmetric membrane may be cast by an immersion precipitation process by casting a cellulose material onto a polyester screen. The polyester screen may be 65 microns thick, 55% open area.

Various two-layer membrane implementations may be manufactured using conventional procedures as added to and improved upon through the procedures described here.

### Use

Implementations of a two-layer membrane are particularly useful in FO/water treatment applications. Such applications may include osmotic-driven water purification and filtration, desalination of sea water, purification of contaminated aqueous waste streams, and the like.

However, implementations are not limited to uses relating to FO applications. Rather, any description relating to FO applications is for the exemplary purposes of this disclosure, and implementations may also be used with similar results in a variety of other applications. For example, two-layer implementations may also be used for PRO systems. The difference is that PRO generates osmotic pressure to drive a turbine or other energy-generating device. All that would be needed is to switch to feeding fresh water (as opposed to osmotic agent) and the salt water feed can be fed to the outside instead of source water (for water treatment applications).

In places where the description above refers to particular implementations, it should be readily apparent that a number of modifications may be made without departing from the spirit thereof and that these implementations may be alternatively applied. The accompanying CLAIMS are intended to cover such modifications as would fall within the true spirit and scope of the disclosure set forth in this document. The presently disclosed implementations are, therefore, to be considered in all respects as illustrative and not restrictive, the scope of the disclosure being indicated by the appended CLAIMS rather than the foregoing DESCRIPTION. All changes that come within the meaning of and range of equivalency of the CLAIMS are intended to be embraced therein.

1. A method of forming a two-layered membrane by immersion precipitation comprising:
depositing a first hydrophilic polymer solution with a formulation optimized to produce a high performance porous layer;
depositing on top of the first hydrophilic polymer solution a second, different hydrophilic polymer solution optimized to produce a high performance dense layer, thereby forming a two-layer polymer solution; and
forming the two-layer polymer solution into one of a forward osmosis membrane and a pressure retarded osmosis membrane by bringing the second, different hydrophilic polymer solution into contact with water to form the dense layer.

2. The method of claim 1, wherein forming the two-layer polymer solution into one of a forward osmosis membrane and a pressure retarded osmosis membrane comprises forming the two-layer polymer solution into one of an asymmetric forward osmosis membrane and an asymmetric pressure retarded osmosis membrane by bringing the second, different hydrophilic polymer solution into contact with water to form the dense layer.

3. The method of claim 2, wherein forming the two-layer polymer solution into one of an asymmetric forward osmosis membrane and an asymmetric pressure retarded osmosis membrane comprises forming the dense layer comprising a thickness of about 5 to about 15 microns and the porous layer comprising a thickness of about 20 to about 150 microns.

4. The method of claim 2, wherein forming the two-layer polymer solution into one of an asymmetric forward osmosis membrane and an asymmetric pressure retarded osmosis membrane comprises forming the dense layer comprising a density of polymer of about 50% or greater polymer by volume and the porous layer comprising a density of polymer from about 15% to about 30% polymer by volume.

5. The method of claim 2, wherein:
depositing a first hydrophilic polymer solution comprises depositing a first cellulose triacetate solution;
depositing on top of the first hydrophilic polymer solution a second, different hydrophilic polymer solution comprises depositing on top of the first cellulose triacetate solution one of a second cellulose acetate butyrate solution and a second cellulose acetate solution, thereby forming a two-layer polymer solution; and
forming the two-layer polymer solution into one of an asymmetric forward osmosis membrane and an asymmetric pressure retarded osmosis membrane comprises forming the two-layer polymer solution into one of:
an asymmetric forward osmosis membrane by bringing the second cellulose acetate butyrate solution into contact with water to form the dense layer; and
an asymmetric pressure retarded osmosis membrane by bringing the second cellulose acetate solution into contact with water to form the dense layer.

6. The method of claim 1, wherein:
depositing a first hydrophilic polymer solution comprises depositing a first cellulose triacetate solution;
depositing on top of the first hydrophilic polymer solution a second, different hydrophilic polymer solution comprises depositing on top of the first cellulose triacetate solution one of a second cellulose acetate butyrate solution and a second cellulose acetate solution, thereby forming a two-layer polymer solution; and
forming the two-layer polymer solution into one of a forward osmosis membrane and a pressure retarded osmosis membrane comprises forming the two-layer polymer solution into one of:
a forward osmosis membrane by bringing the second cellulose acetate butyrate solution into contact with water to form the dense layer; and
a pressure retarded osmosis membrane by bringing the second cellulose acetate solution into contact with water to form the dense layer.

7. A two-layered membrane formed by immersion precipitation comprising:
a porous layer formed from a first hydrophilic polymer solution with a formulation optimized to produce a high performance porous layer; and
a dense layer on top of and supported by the porous layer, the dense layer formed from a second, different hydrophilic polymer solution optimized to produce a high performance dense layer.

8. The membrane of claim 7, wherein the membrane is an asymmetric membrane.

9. The membrane of claim 8, wherein the dense layer comprises a thickness of about 5 to about 15 microns and the porous layer comprises a thickness of about 20 to about 150 microns.

10. The membrane of claim 8, wherein the dense layer comprises a density of polymer of about 50% or greater polymer by volume and the porous layer comprises a density of polymer from about 15% to about 30% polymer by volume.

11. The membrane of claim 8, wherein the asymmetric membrane comprises one of an asymmetric forward osmosis membrane and an asymmetric pressure retarded osmosis membrane.

12. The membrane of claim 8, wherein the asymmetric membrane comprises an asymmetric forward osmosis membrane with the porous layer formed from a first cellulose triacetate solution and the dense layer formed from a second cellulose acetate butyrate solution.

13. The membrane of claim 8, wherein the asymmetric membrane comprises an asymmetric pressure retarded osmosis membrane with the porous layer formed from a first cellulose triacetate solution and the dense layer formed from a second cellulose acetate solution.

14. The membrane of claim 7, wherein the membrane comprises a forward osmosis membrane with the porous layer formed from a first cellulose triacetate solution and the dense layer formed from a second cellulose acetate butyrate solution.

15. The membrane of claim 7, wherein the membrane comprises a pressure retarded osmosis membrane with the porous layer formed from a first cellulose triacetate solution and the dense layer formed from a second cellulose acetate solution.
